(19) United States
(12) Patent Application Publication
(10) Pub. No.: US 2002/0165697 A1
(43) Pub. Date: Nov. 7, 2002

(54) Analysing method of soccer game data by use of computer network, system thereof, and computer-readable medium recording analysing program

(76) Inventor: Daekee Min, Seoul (KR)

Correspondence Address: KNOBBE MARTENS OLSON & BEAR LLP, 2040 MAIN STREET, FOURTEENTH FLOOR, IRVINE, CA, 91614, US

(21) Appl. No.: 10/031,428

(22) PCT Filed: May 15, 2001
(86) PCT No.: PCT/KR01/00785

(30) Foreign Application Priority Data
May 17, 2000 (KR) 2000-26524

(51) Int. Cl. G06F 15/00

(52) U.S. Cl. 702/183

(57) ABSTRACT

The present invention relates to a method and a system of analyzing soccer game and recording medium where they are recorded using computer network, thereby precisely analyzing the game record and improving player's skill. According to the method, if a user inputs command of analyzing, the information regarding the trace of a ball, kind of pass and the trace of the players are transferred to positional information in a soccer field and said positional information is displayed in a result window as point, line, letter/number, color, etc. Thus, since the player's skill of each team can be sufficiently analyzed, player's and team's skills are improved accordingly. Further, since high value added analysis is provided through various function or area division, the real time analysis of the soccer game is possible. In addition, the analysis information is publicly distributed and new business model is created.

### FIELD OF THE INVENTION

The present invention relates to a method of soccer game data analysis using computer network, systems thereof, and computer compatible recording media for the data. More particularly, the present invention relates to the method of soccer game data analysis using computer network, systems thereof, and computer compatible recording media for the data, which enables every user to enhance the ability of skill development of players and the capability of a team via searching various soccer game data in easily accessible way.

Internet is comprised of tremendous number of computers and the computer networks which link the computers to communicate with each other.

The mutually connected computers exchange information using various services such as electronic mail, gopher, and world wide web (WWW). World wide web allows a server computer system (for example, web-server or website) to send graphical web pages to remote clients' computer systems.

The remote clients' computer system as such can display the received web pages in computer screens.

### TECHNICAL BACKGROUND

According to rapid progress of Internet, services enabling users to view real time sports game data or previous ones are provided in cyber space.

However, although a game data recording professional records game data in detail and one views the data via Internet, it is impossible for users to analyze the strengths and weaknesses of a team or a player in detail using the unprocessed data.

Especially, it was very hard to analyze the attack and defense pattern, game domination rate, and movement of each player, all of which demand a lot of calculations and function process, so that sports game data support services were not provides well enough. Thus, coaching staffs, players, and fans could not utilize the information either.

Also, it was hard to analyze the data promptly and spontaneously because it took much time and efforts to do soccer game data analysis. Furthermore, since it was hard to understand the analysis comprised of various numerical data, the information was provided for not very many users.

### DETAILED DESCRIPTION OF THE INVENTION

Therefore, an object of the present invention to resolve the mentioned problems is to provide a method of soccer game data analysis using computer network, systems thereof, and computer compatible recording media for the data, which make it possible to provide information, easy to understand for users, promptly so that the user can analyze players' movements in detail using various option selections, prove the capability of teams and players, and enhance the capability of the teams and players.

It is another object of the present this invention to share the analysis information with non-professional users and to provide the high profitable methods of soccer game data analysis using computer network, systems thereof, and computer compatible recording media for the data, which can provide information promptly and simply so that users should be able to analyze a game in real time, and are provided in graphics so as to make it possible for users to understand the analysis.

### BRIEF DESCRIPTION OF THE DRAWINGS

FIG. 1 is a schematic diagram illustrating a soccer game data analysis system using computer network according to a preferred embodiment of the present invention.

FIG. 2 is a block diagram showing a method of soccer game data analysis using computer network according to a preferred embodiment of the present invention.

FIG. 3 illustrates a sample page showing result window and statistics window.

FIG. 4 is a sample page showing a graphic page displayed on the result window.

FIGS. 5-6 illustrate examples of option selection page.

FIG. 7 shows an example of penalty kick selection window page.

FIG. 8 shows an example of penalty kick result window page.

FIG. 9 shows an example of attempt distribution in a goal page.

FIG. 10 illustrates an example of record table storing X and Y coordinates.

FIG. 11 is a large view of a result window of graphic page.

FIG. 12 is showing a playground divided into 12 areas.

FIG. 13 shows an example page of result window when full option is selected.

FIG. 14 shows an example page of result window when 15 minutes option is selected.

FIG. 15 shows an example page of pattern result window when specific team (for example, Netherlands) in full option is selected.

FIG. 16 shows an example page of result window when game record data for an individual player is selected.

FIG. 17 illustrates examples of variables where the counts of areas of the playground are stored.

FIG. 18 shows an example page of result window for shoot.

FIG. 19 shows an example page displaying graphics page successively.

FIG. 20 shows an example page displaying 5 previous steps before goal.

FIG. 21 shows an example result window displaying a corner kick.

FIG. 22 shows an example result window displaying a free kick.

FIG. 23 shows an example page presenting player list.

FIG. 24 shows an example page displaying defense positions of the players.

FIG. 25 shows an example page finding and displaying 6 players who placed a ball into a specific area.

FIG. 26 shows an example page displaying the game domination rate as a graph form.

### PREFERRED EMBODIMENTS

The soccer game record data analysis method using computer network is utilizing at least one user computer and a server computer connected to each other through computer network. In response to user's instruction of analysis, it converts type of passing and moving paths of a ball and players into plane location data on a playground, and displays the above-mentioned location data using points, lines, characters/numbers, and color on the result window showing a playground.

According to the method of analyzing soccer game record data using computer network, the computer network is equipped with at least one user computer and a server computer connected to each other through computer network and the server computer comprises a game record database which stores soccer game record data, location data converting program which converts soccer game record data into location data, and result window display program which display the location data on a result window. Also, the method of analyzing soccer game record data is characterized in that the method comprises the steps of (a) selecting at least one command(s) transferred from user computer to the server computer through the computer network; (b) converting the soccer game record data into the location data using the location data converting program; and (c) displaying the location data graphically onto the result window of the user's computer using the result window displaying program.

In the step (b), it is preferable to include the steps of finding the record data corresponding to option condition of option selection step out of record data which contain soccer game record data and the X and Y value of the location where the record occurred using result function, saving the found location data, and saving the information about the selected option and the image data of graphic page corresponding to the location data.

In the step (b), it is possible to split the playground into 12 areas, trisection along the side line and quadrisection along the goal line, record which area each player is located in, and count it using “Count( )” function and “CountArea( )” function, which can be utilized of various statistics and graphics.

In the method of soccer game record data analysis using computer network, the server computer has a statistics window display program, which displays various statistics based on the analysis on the soccer game record data onto a statistics window, and the method further comprises a step of (d) displaying the statistics based on the analysis on the soccer game record data as a numerical form onto the statistics window using the statistics window displaying program.

The soccer game record data analysis system using computer network according to the present invention comprising at least one user computer and a server computer connected to each other through computer network, the server computer comprising a game record database which stores soccer game record data, the location data converting program which converts soccer game record data into location data, the result window display program which display the mentioned location data on a result window, and a control unit which is programmed to, when a user selects at least one command to the server computer via the computer network, convert the soccer game record data into location data using the location data converting program and graphically display the location data onto the result window of the user's computer using the result window display program.

Computer compatible record media of the present invention stores a method of analyzing the soccer game using computer network utilizing at least one user computer and a server computer connected to each other through computer network. According to the present invention, the server computer comprises a game record database which stores soccer game record data, location data converting program which converts soccer game record data into location data, and result window display program which display the mentioned location data on a result window. Also, the method of analyzing soccer game record data is characterized in that the method comprises the steps of (a) selecting at least one command(s) transferred from user computer to the server computer through the computer network; (b) converting the soccer game record data into the location data using the location data converting program; and (c) displaying the location data graphically onto the result window of the user's computer using the result window displaying program.

Now, the soccer game record data analysis method using computer network and analysis system using the same according the a preferred embodiment of the present invention are described in detail with reference to the accompanying drawings.

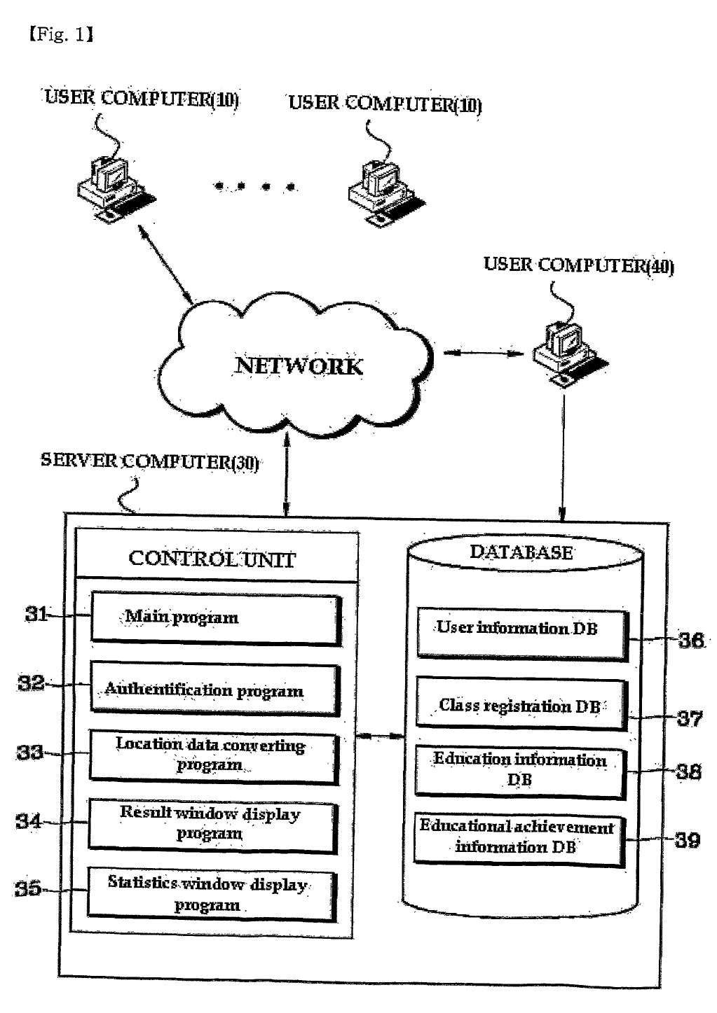

As showed in FIG. 1, the soccer game record data analysis system according the preferred embodiment of the present invention comprises user computers 10, a network 20, a game data recorder computer 40, and a server computer 30.

The network connects the user computers and the server computer and can be a PSTN (public switched telephone network), ARS, and/or wire/wireless Internet. The spirit of this invention cannot be confined to a certain type of network and the meaning of the network should be interpreted to include all of the communication methods in the broadest meaning.

The above-mentioned server computer 30 is a computer equipped in the service providing part to provide the soccer game record data analysis methods.

The above-mentioned user computers 10 are connected to the server computer 30 and these are the terminals to input command condition and receive an analysis result. The user computer is a terminal such as a personal computer, PDA, or a portable communication tool like wireless phone to output the analysis result from the server computer via wire or wireless communication and is not confined specifically.

The game data recorder computer 40 inputs various soccer game record data into the server computer 30.

The server computer 30 and the user computer 10 are connected to each other through the network 20. The user computers connected to the network 20 have Internet browser applications, for example Internet Explorer, which can display web contents using HTML and XML.

The server computer 30 comprises the programs and databases which are needed to realize the soccer game record data analysis method of the present invention.

The program constitutes a control unit, and the control unit comprises a main program 31 which manages the whole program, an authentication program 32 which authorizes user information, a location data converting program 33 which converts the soccer game record data into the location data, a result window display program 34 which displays the location data onto a result window, and a statistics window display program 35 which displays various statistics based on the analysis on the soccer game record data onto the statistics window.

The database comprises a user database 36 where user information is stored, a game record database 37 where soccer game record data is stored, a graphic page database 38 where location data is stored, and a statistics information database 39 where various statistics are stored.

In other word, the server computer 30 is equipped with the control unit and the database and present to users through a network, such as Internet, in the form of a website

A user connects to the server computer 30 using the user computer 10, executes the main program 31, and the user is authorized according to the user information of the user database 36. After authorization, the user selects a command condition to the server computer, the game record data stored in the game record database is converted into location data by the location data converting program 33, and the location data is saved in the graphic page database 38 and transmitted to the user computer 10 by the result window display program 34.

If the user wants, various statistics information is saved after analysis of the various statistics and can be transmitted to the user computer 10 by the statistics window display program 3).

The authentication program 32 can be developed in various ways and the above-mentioned authentication program can be edited and changed by the person skilled in the art.

Following is a stepwise explanation about the process.

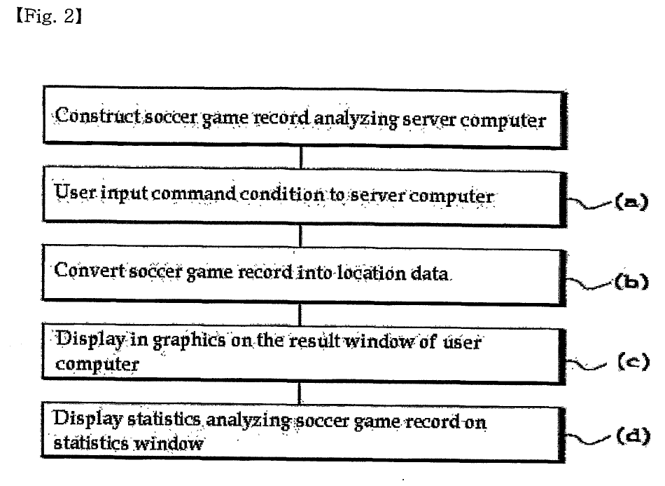

The soccer game record data analysis method using computer network, according to the preferred embodiment of the present invention, is to convert moving paths of the ball, type of passing and moving paths of players into planar location data of a playground in response to a user's input of a command of analysis, and to display the location data using symbols such as points, lines, characters/numbers, and colors on the result window showing a playground, and the method comprising the steps of, as shown in FIG. 2, constructing the above-described server computer, (a) selecting at least one command(s) transferred from user computer to the server computer through the computer network; (b) converting the soccer game record data into the location data using the location data converting program; (c) displaying the location data graphically onto the result window of the user's computer using the result window displaying program; and (d) displaying various statistics based on the analysis on the soccer game record data as a numerical form onto the statistics window using the statistics window displaying program.

The said step (a) is divided into a game selection step, a time selection step, and an option selection step, where the said game selection step is to select a team/date/place/sponsership/1^{st}-2^{nd} half/player/coach which a user wants to analyze.

The said time selection step is for a user to select a specific time period from either of 1^{st} or 2^{nd} half.

The said option selection step is to select information to be output such as; shoot type (right foot shoot/left foot shoot/heading shoot/etc.), impact point, name/number of the player passing or receiving, type of ball (on ground/off ground ball), kind of event, goal success or fails, position of a player before shoot, diving direction, goalkeeping type, motion, attempt distribution in a goal/score/team success rate/success rate in total, pattern of attack, assist, and defense (clearing/intercept/cutting/block), individual game record, individual movement, defense position, ball possession time, and game domination rate (defined as the rate between the number of touching a ball per five minute for each team).

Thus, it is possible to provide information promptly and easy to understand for users so that the user can analyze players' movements in detail using various option selections, prove the capability of teams and players, and enhance the capability of the teams and players

The step (b) includes the steps of finding the record data corresponding to option condition selected in the option selection step out of record data which contain soccer game record data and the X and Y value of the location where the record occurred using result function, saving the X and Y value of the found record as the location data, and saving the information about the selected option and the image data of graphic page corresponding to the location data.

Since the analysis result is provided in easily understandable graphics, it is possible to serve more people and thus create new profit.

The step (b) is to split the playground into 12 areas, trisection along the side line and quadrisection along the goal line, record which area each player is located in, and count it using “Count( )” function and “CountArea( )” function, which can be utilized of various statistics and graphics.

Since it is possible to provide high profit value added analysis information simply and promptly, so is to analyze a soccer game in real time.

The step (c) can display at least one saved graphic page independently and/or at the same time in the result window, and overlap the information about the selected option.

The graphic page describes the location of a player with a point on which number of the player and passing type are added, team with a color, dribbling distance with a dotted line, and passing distance with a solid line.

The graphic page comprises a pattern page enabling to see players' location pattern and an individual game record page to check an individual player's game record.

Now, a preferred embodiment of the soccer game record data analysis method using computer network is described in more detail with the windows shown on users' computer screen.

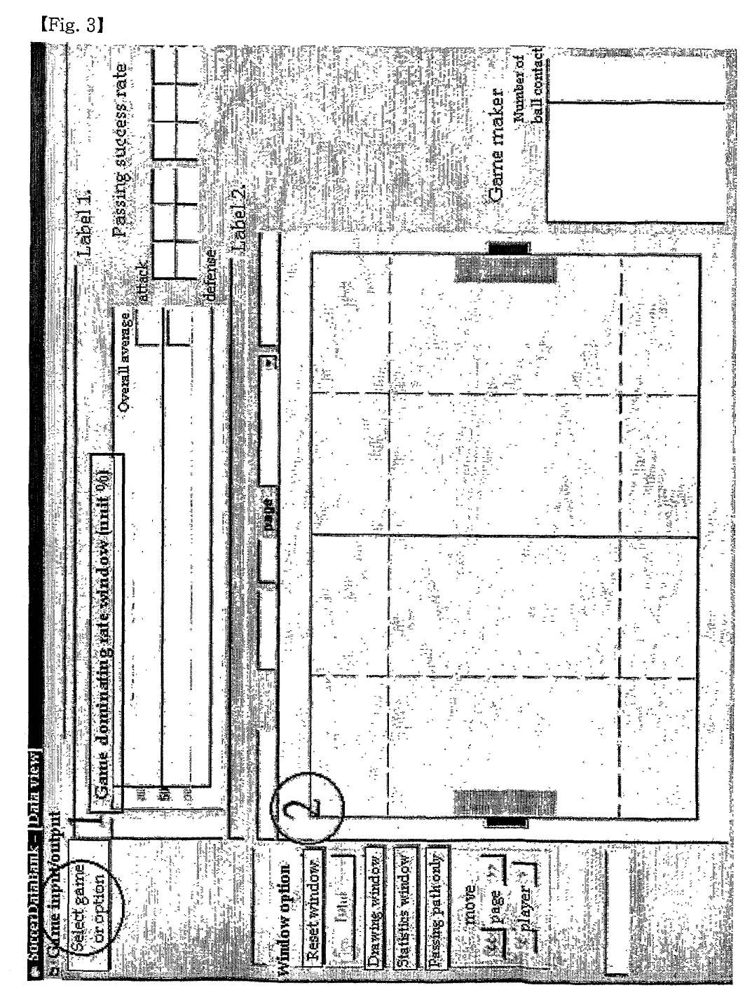

As shown in FIG. 3, the screen provided to users is divided by the game domination rate window (area 1) and the other for other information (area 2), and detailed information of a game (team name, date of the game, place, sponsorship, 1^{st}-2^{nd} half, and team selection) is displayed on Label 1 and Label 2. Then, a user selects game and option with “Select game or option” button.

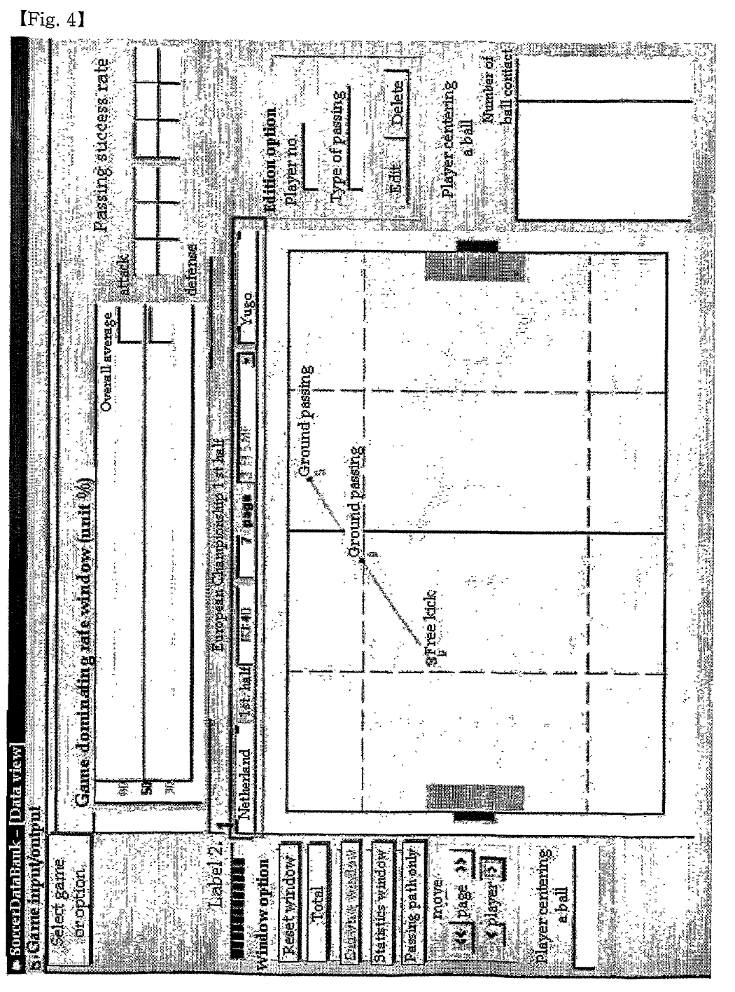

For example, as shown in FIG. 4, Label 2 informs that the displayed result is for 1^{st} half of the game between Netherlands and Yugoslavia on 06-26.

Here, page move and player move were selected in the view option. Red-Netherlands on left side of area 1 means that Netherlands attacked to right side (which means left side is Netherlands' area) and the present result shows that Zenden of number 5 did an on ground pass at 3′ 40″ of the 1^{st} half. (S stands for ‘Start’; number 0 did a direct free kick, number 0 received and did a on ground pass, then number 5 received and did an on ground pass.)

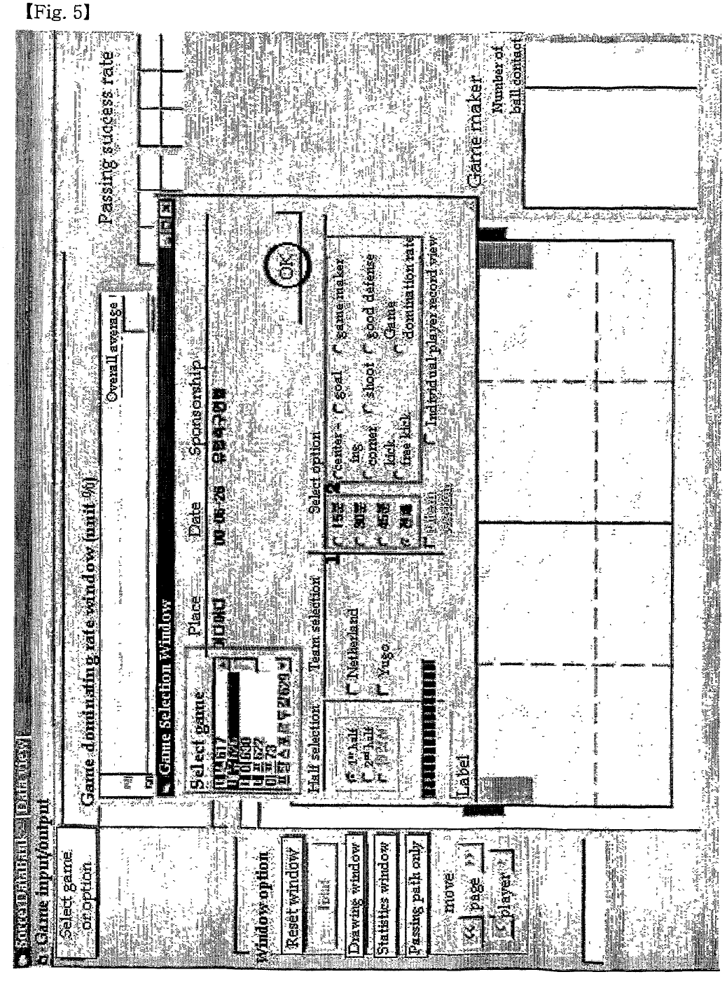

As shown in FIG. 5, a user selects a game at first. While selecting a game, for example “NeYu 626” in a game selection table, the user can also see the place, data, sponsorship, and name of the teams on the window.

The option selection is divided by two parts. Options of the area 1 are for drawing patterns (pattern selection checkbox at the bottom of the area 1) and individual player's game record (individual player record view checkbox). If the team selection checkbox is not checked, both teams are selected, user can see result for the team only while if one is checked. Labels display the result the selected option will show. If a user clicks OK button, the result of selected game, 1^{st}-2^{nd} half, and team, following the selected option, is shown. (default value of 1^{st}-2^{nd} half is 1st half and option is the whole game.)

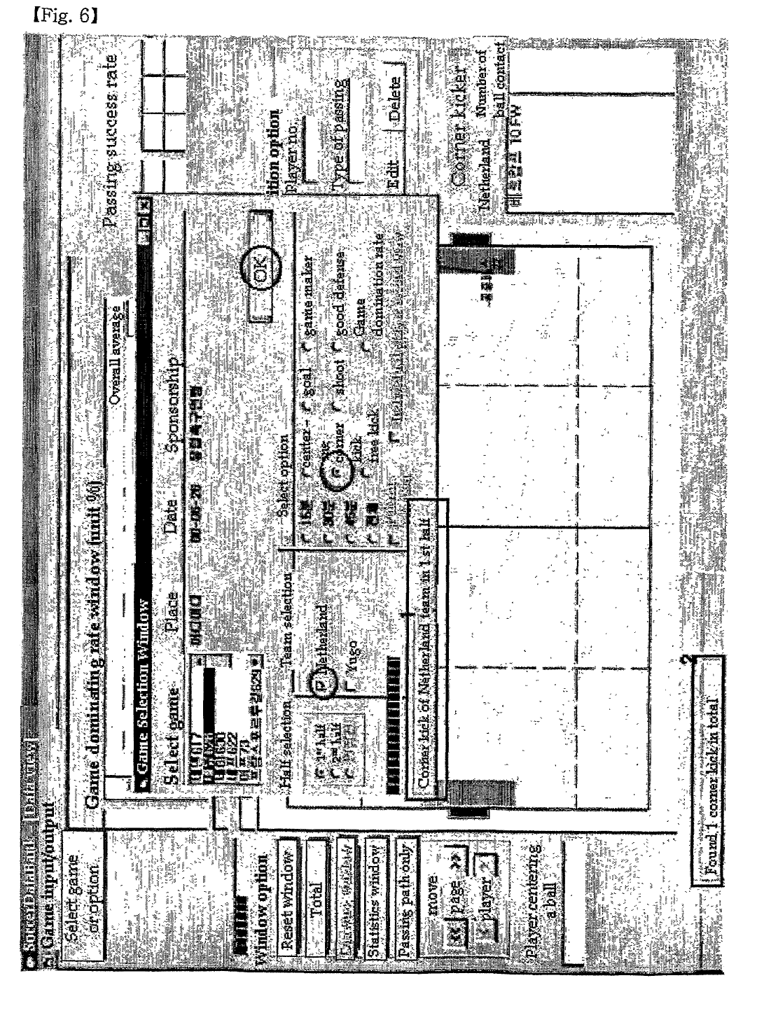

As shown in FIG. 6, in “NeYu 626” game, a user can see that a corner kick of Netherlands is to be shown from area 1, which will be shown in the data view window if OK button clicked. User can see that one corner kick was found in total in area 2.

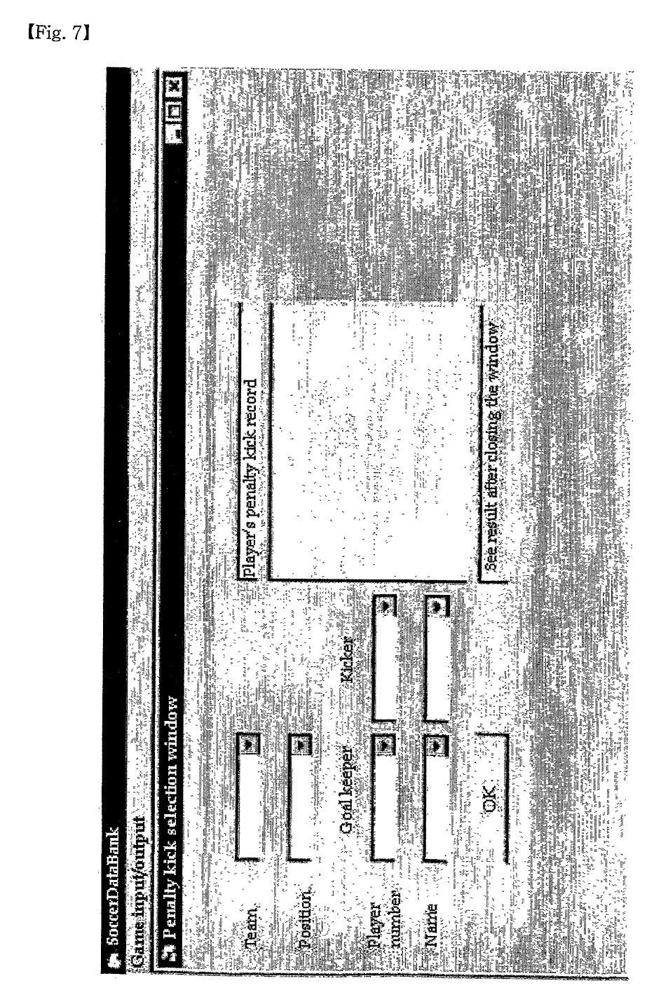

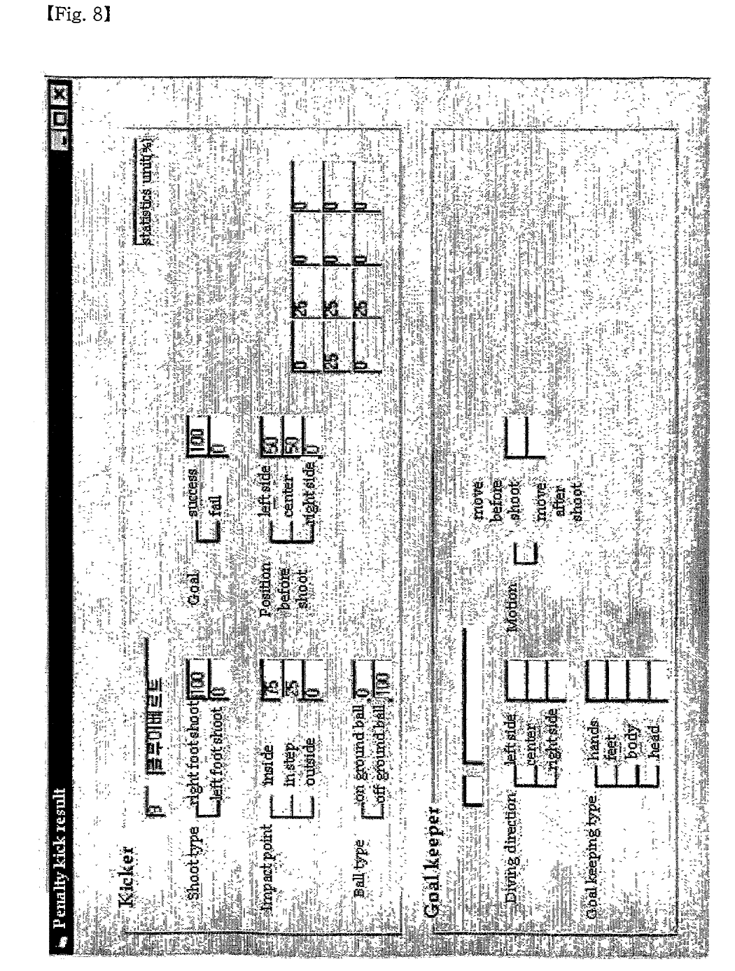

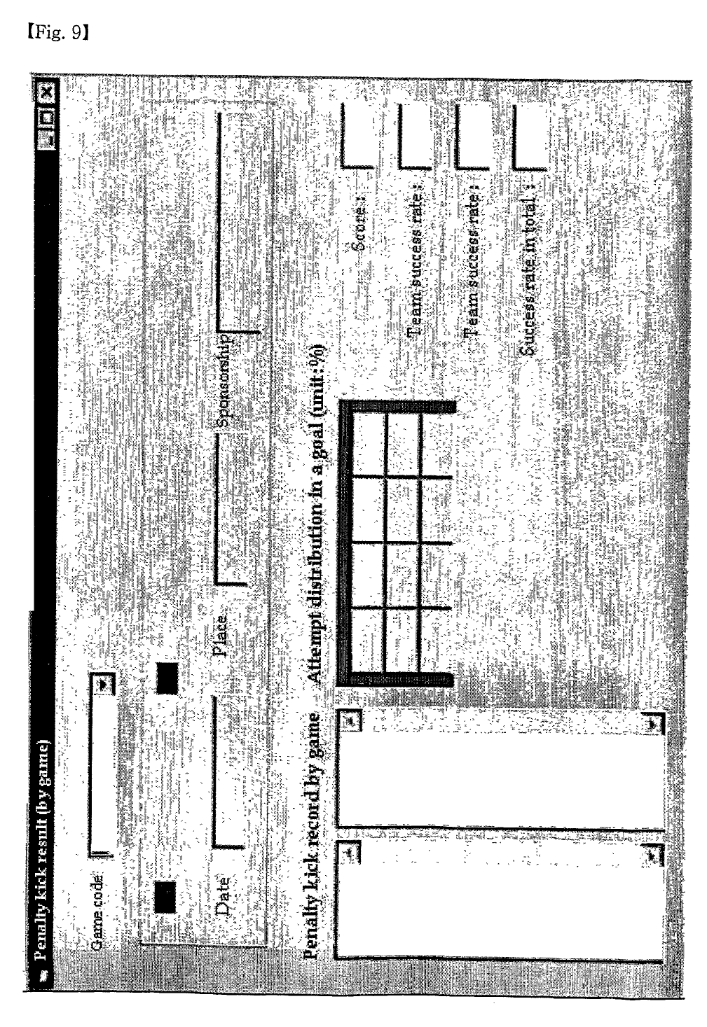

As shown in FIGS. 7-9, a user can see penalty kick information of a game if the user selects penalty kick view commands and game code.

In more detail of searching the game record in the table, for “NeYu 626”, 15, 30, and 45 minutes button corresponds to the game record for game start to 15 minutes, 15 minutes to 30 minutes, and 30 minutes to 45 minutes respectively.

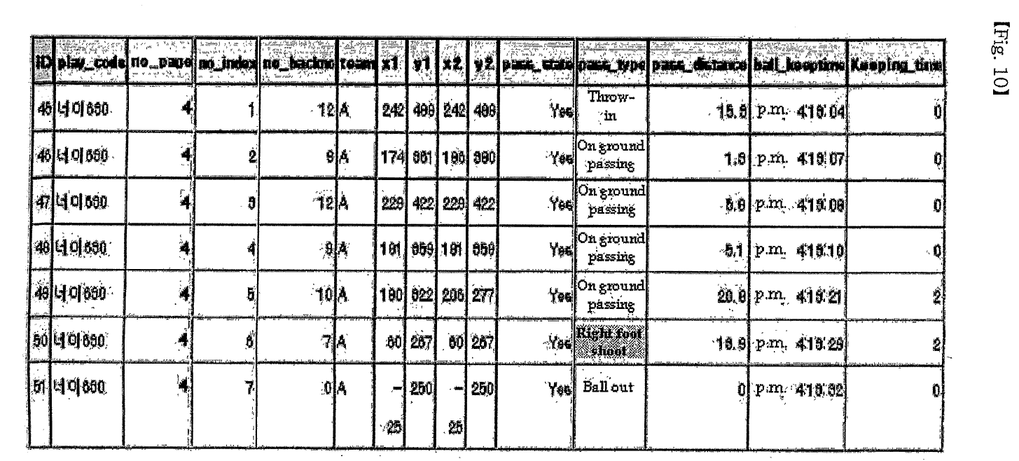

As shown in FIG. 10, various information is stored in table, which is exemplified in the following.

Player whose number is 12 of A team passes to number 9 of the same team by throw-in at 4:13 and 4 seconds. Number 9 of team A at x1, y1 receives the ball at 4:13 and 7 seconds, dribbles it to x2, y2, and does on ground pass. If there is no dribble, x1, y1 should be same as x2, y2. The passed ball is out of sideline at 7^{th} pass (no_index) and page (no_page) increases. The increase of page without index means that there occur ball out, goal in or foul.

The displayed graphic page can go to next or previous page as user click buttons and the motion of a player can be shown individually in the page.

PageDraw( ) and DotDraw( ) functions are used to draw pictures on window when move page or move player command occur.

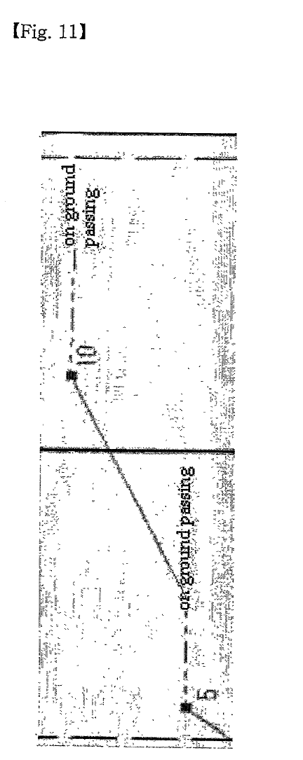

As shown in FIG. 11, set a position with coordinates (x1, y1 in the table), write a number of player and type of pass, and divide team with colors (red, blue). Dotted line is used to draw dribble distance (from x1, y1 to x2, y2) and solid line to draw pass distance (present player (x1, y1) to receiving player (x2, y2)). Form of drawing lines of PageDraw( ) and DotDraw( ) function changes depending on occasion. In the example, number 5 received a ball, dribble, and pass on ground (x2, y2) and number 10 received ball, dribble, and pass on ground.

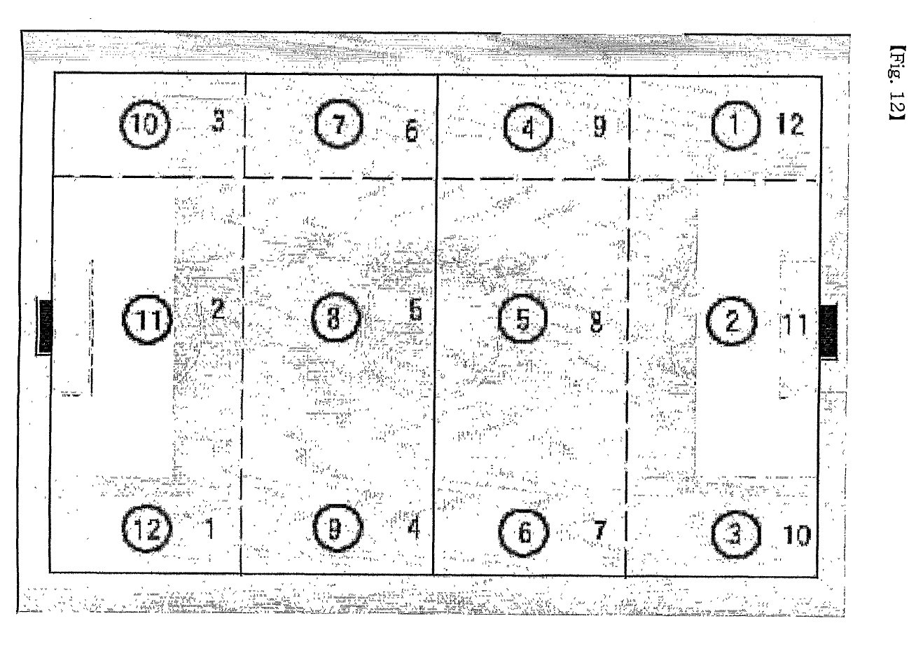

As shown in FIG. 12, a playground is divided into 12 areas, trisection along the side line and quadrisection goal line with respect to each team's attack direction.

For example, when a team attacks toward the right side, area numbers are 12, 11, and 10. On the contrary, area numbers become 1, 2, and 3 when the team attacks toward the left side. Area number 1 comes to the left side of the attack direction.

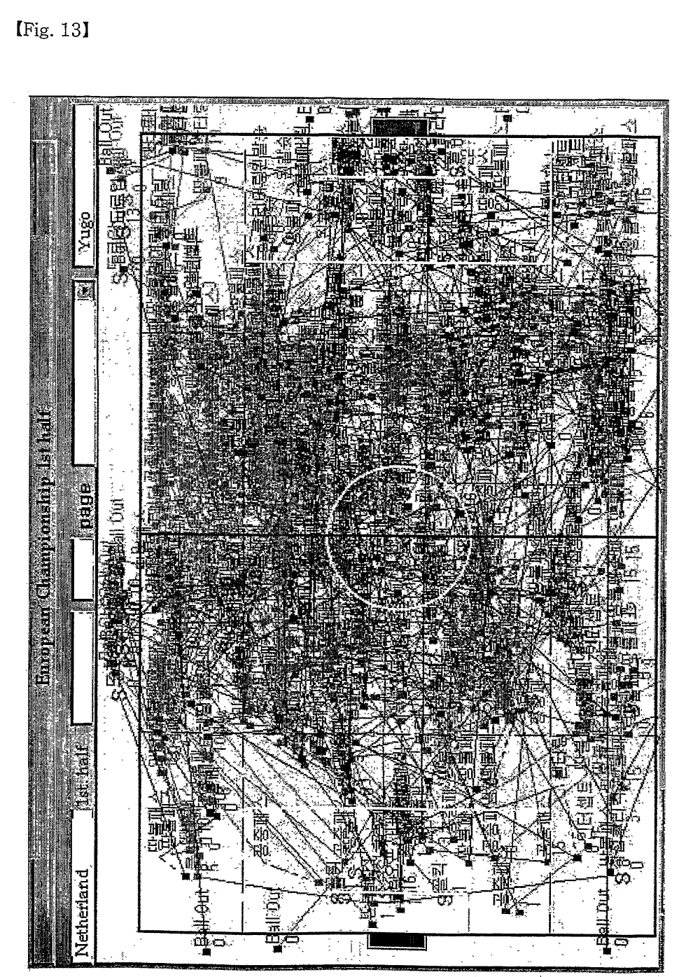

As shown in FIG. 13, there are 15 minutes, 30 minutes, and 45 minutes options in displayed game period and full option is processed by Total( ) function, which saves from starting page of the 1^{st} half (page 1) to the last page (if there is the 2^{nd} half, page for the starting page of the 2^{nd} half−1, if not, the last page of the game) in the Page( ) variable and outputs a result such as FIG. 13.

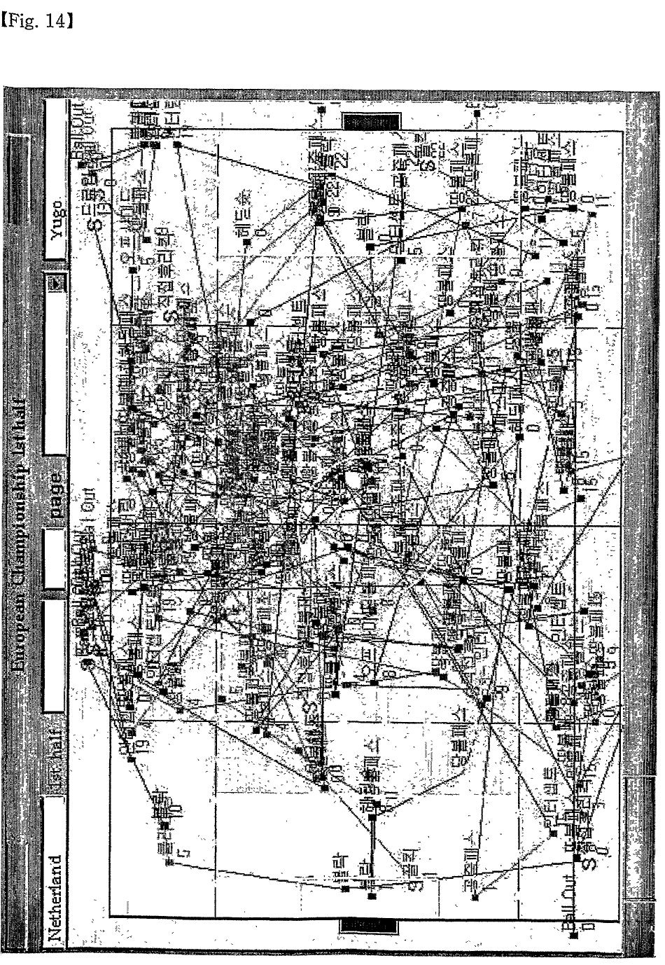

As shown in FIG. 14, pages until 15 minutes of a game are displayed if the game period is 15 minutes.

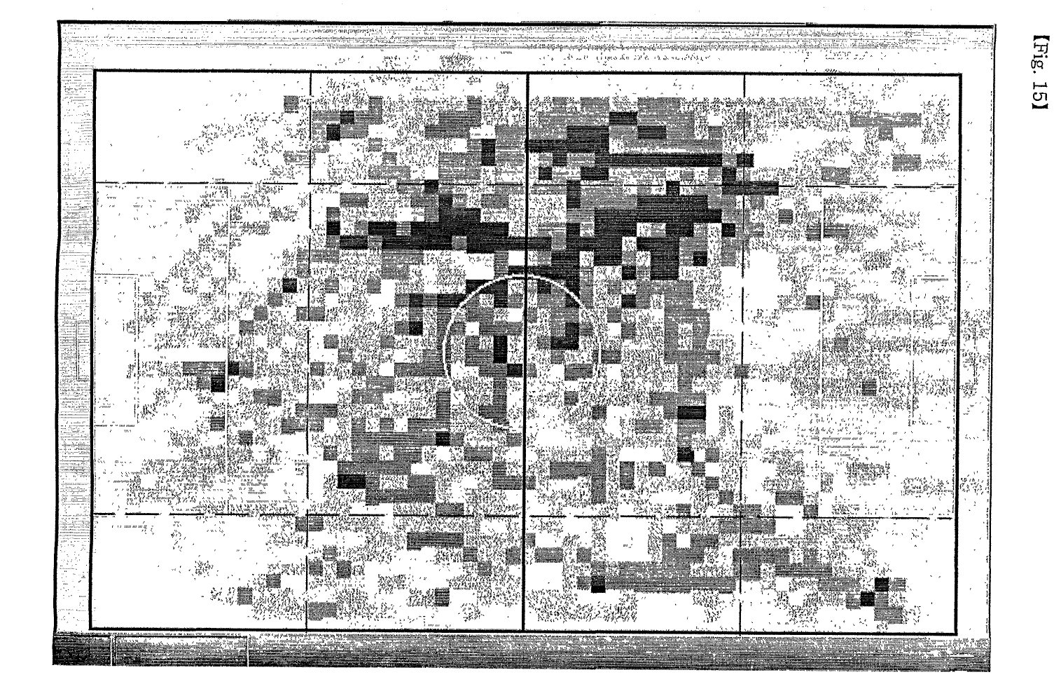

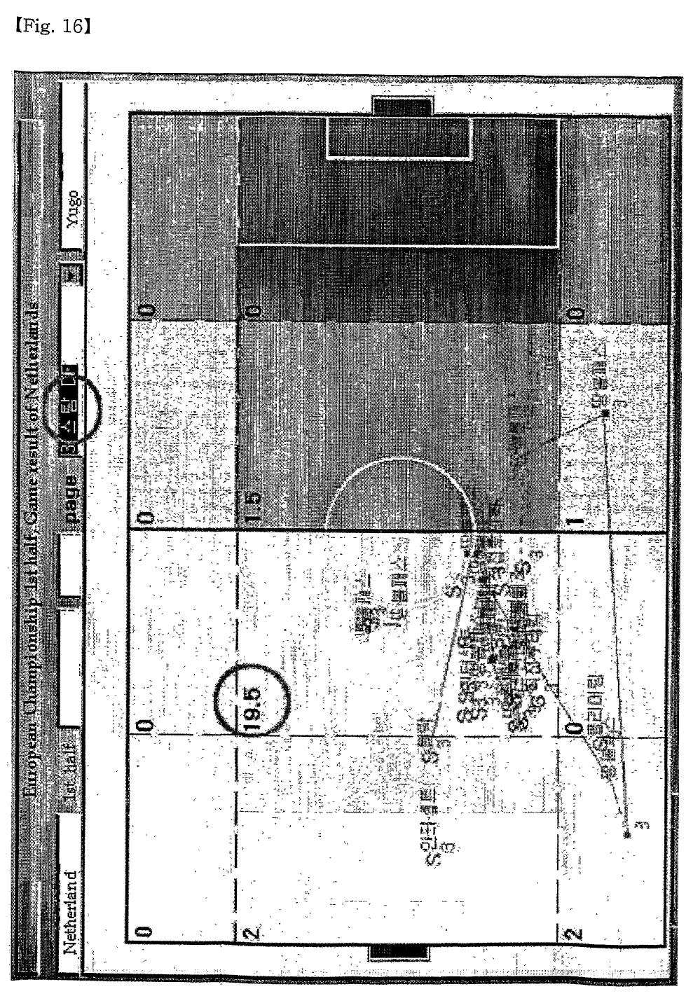

As shown in FIG. 15, if a user commands a pattern selection, user can see the patterns for 15 minutes, 30 minutes, 45 minutes, and full options.

As shown in FIG. 15, game record data for an individual player can be shown in detail. If a user selects a player, the player's moving path and count for each area are shown as in FIG. 15.

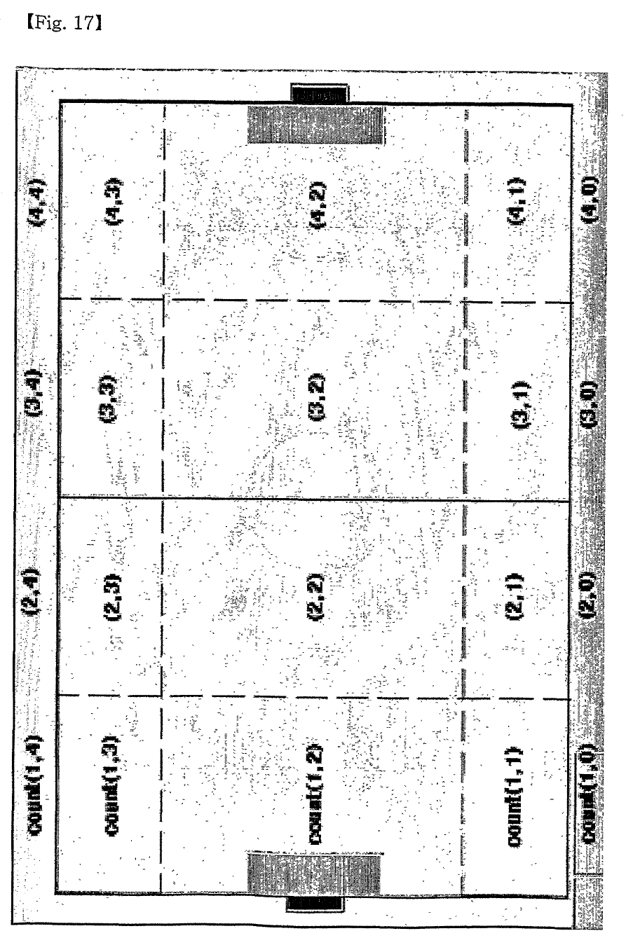

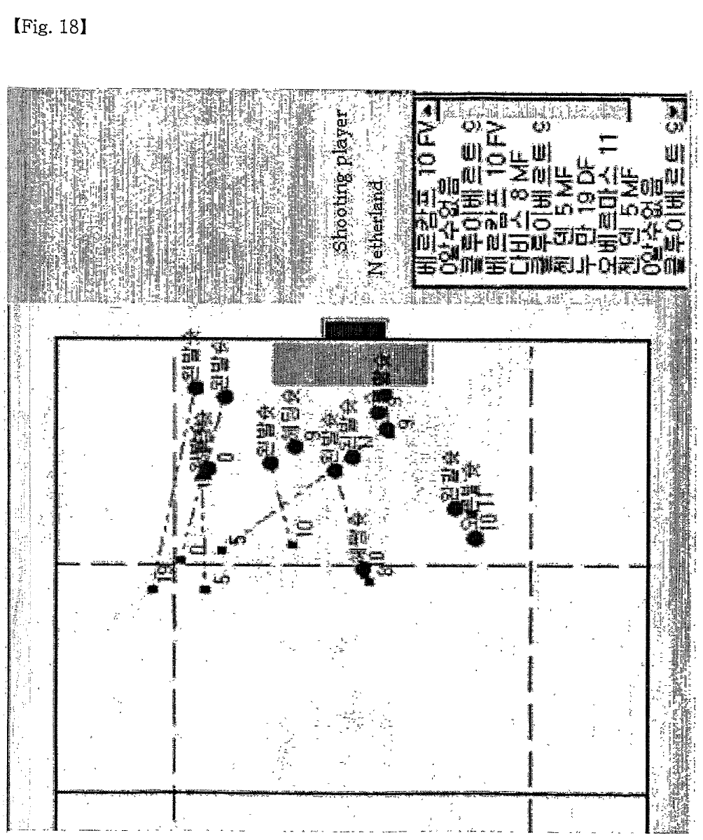

Areas of playground can be displayed as shown in FIG. 17, where the areas out of playground can be assigned such as (1,0), (2,0), and (3,0) to count the throw-ins.

Especially, a code for counting number of times a player is located in a certain area in x-y coordinate is shown in the following.

“Count(1,1) is area 1 when attacking toward the left side and 12 toward the right.

Private Function schArea(x As Single, y As Single, Optional ii As Integer)

Dim i, j As Single

Dim ar As Single

If x>=0 And x<183.75 Then

If y>=478 Then

ElseIf y>=378 And y<478 Then

‘area 1 (left side attack)−area 12 (right side attack)

−>Since it is area 1, put i=1, j=1 to increase count of

CountArea(1,1)

ElseIf y>=96 And y<378 Then

‘area 2−area 11

ElseIf y>=0 And y<96 Then

‘area 3−area 10

ElseIf y<0 Then

End If

ElseIf x>=183.75 And x<367.5 Then

If y>=478 Then

ElseIf y>=378 And y<478 Then

‘area 4−area 9

ElseIf y>=96 And y<378 Then

‘area 5−area 8

ElseIf y>=0 And y<96 Then

‘area 6−area 7

Elseli y<0 Then

End If

ElseIf x>=367.5 And x<551.25 Then

If y>=478 Then

ElseIf y>=378 And y<478 Then

‘area 7−area 6

ElseIf y>=96 And y<378 Then

‘area 8−area 5

ElseIf y>=0 And y<96 Then

‘area 9−area 4

ElseIf y<0 Then

End If

Elself x>=551.25 And x<735 Then

If y>=478 Then

ElseIf y>=378 And y<478 Then

‘area 10−area 3

ElseIf y>=96 And y<378 Then

‘area 11−area 2

ElseIf y>=0 And y<96 Then

‘area 12−area 1

ElseIf y<0 Then

End If

End If

If ii<>1 Then

CountArea(i, j)=CountArea(i, j)+1

−increase count

Else

schArea=ar−>area number

−return area number

End If

End Function”

In an individual game record data, both of x1, y1 and x2, y2 are searched, i.e. searching twice for an individual player's moving. That is because area for x1, y1 may be different from one for x2, y2 when the player is dribbling, but counted CountArea( ) will be divided by 2, which is why number such as 0.5 occurs. In the figure, the player Stam had a ball most frequently (19.5) in area 8.

Now, the calculated count is written in corresponding area. Following is an example of code for writing the counted CountArea( ).

“Private Sub printCount( )

Picture1.FontBold=True

Picture1.FontSize=12

There are left foot shoot, right foot shoot, heading shoot, and etc. in the kinds of shoot.

Also, area of a player who passed a ball to enable another player to shoot it (assist, in case of a goal) is pointed and counts of it can be displayed in each area, which is processed in the similar way with that of the individual player game record.

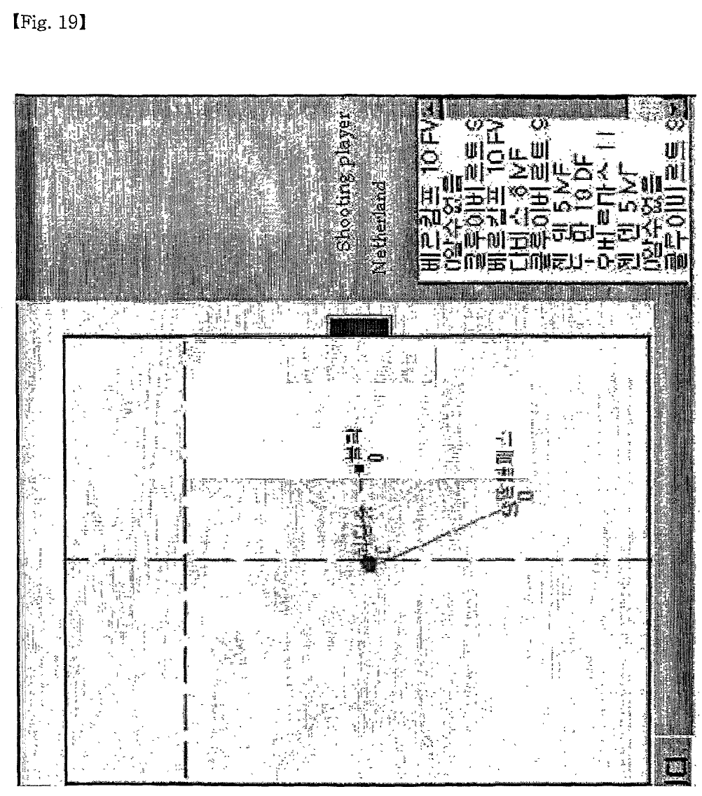

As shown in FIG. 19, each page is shown in order of time a shoot is happened, but can show a shooter, a previous pass, and a next pass only. FIG. 19 shows the 1^{st} shooting situation, which is, number 0 pass on ground, return it with heading shoot, but resulted in being blocked by number 0 of the other team.

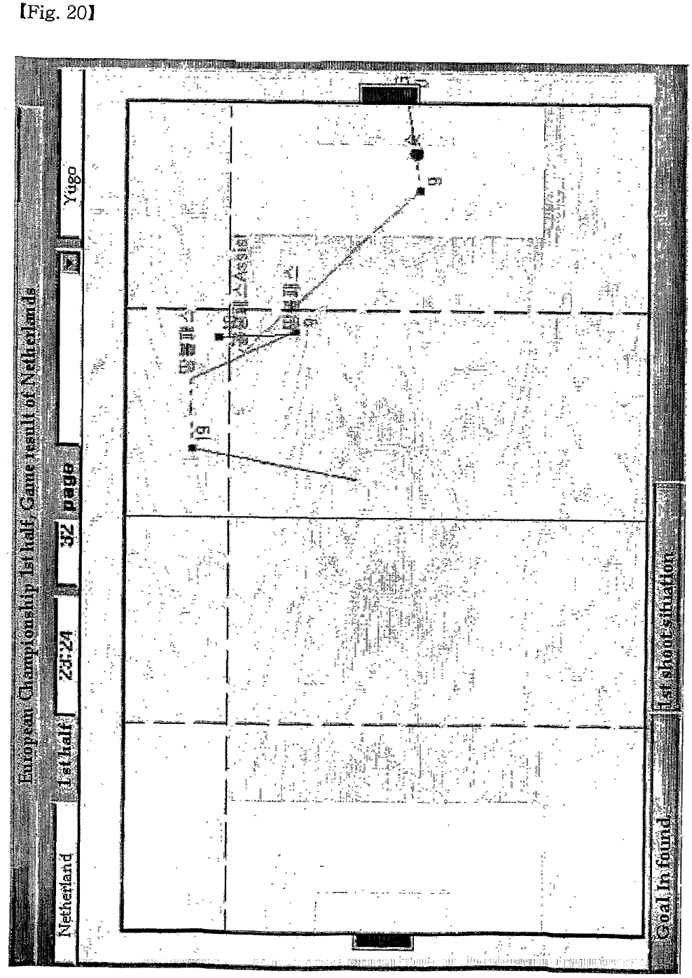

As shown in FIG. 20, when a goal option is selected, 5 previous steps before goal are presented.

This window can show in more detail as to the whole steps to goal by selecting move player command.

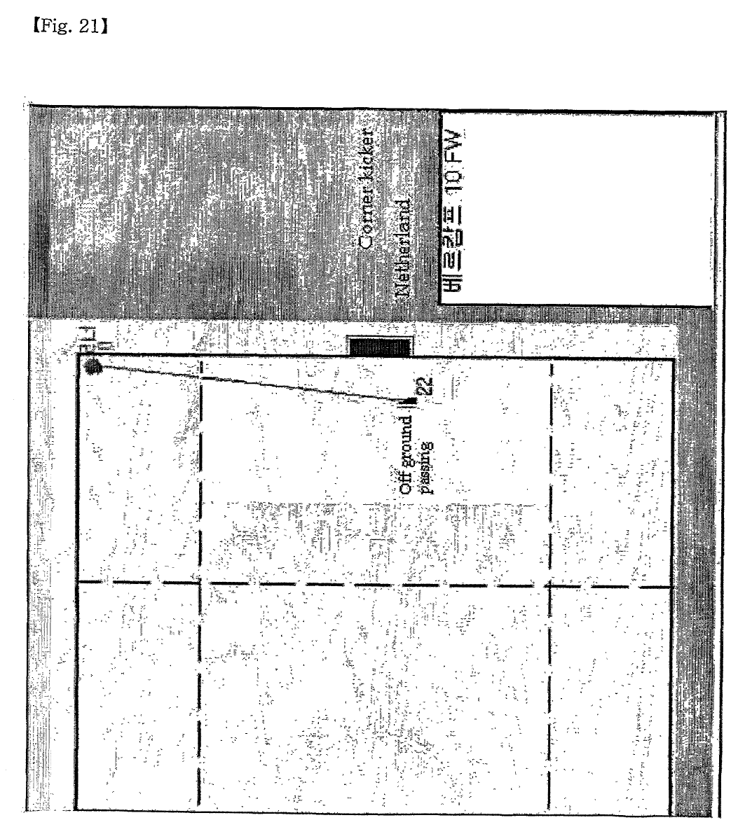

As shown in FIG. 21, since it is important to see in what angle a corner kick was placed with respect to a goal line, the next step after a comer kick can be displayed. In this case, name of corner kicker is presented also.

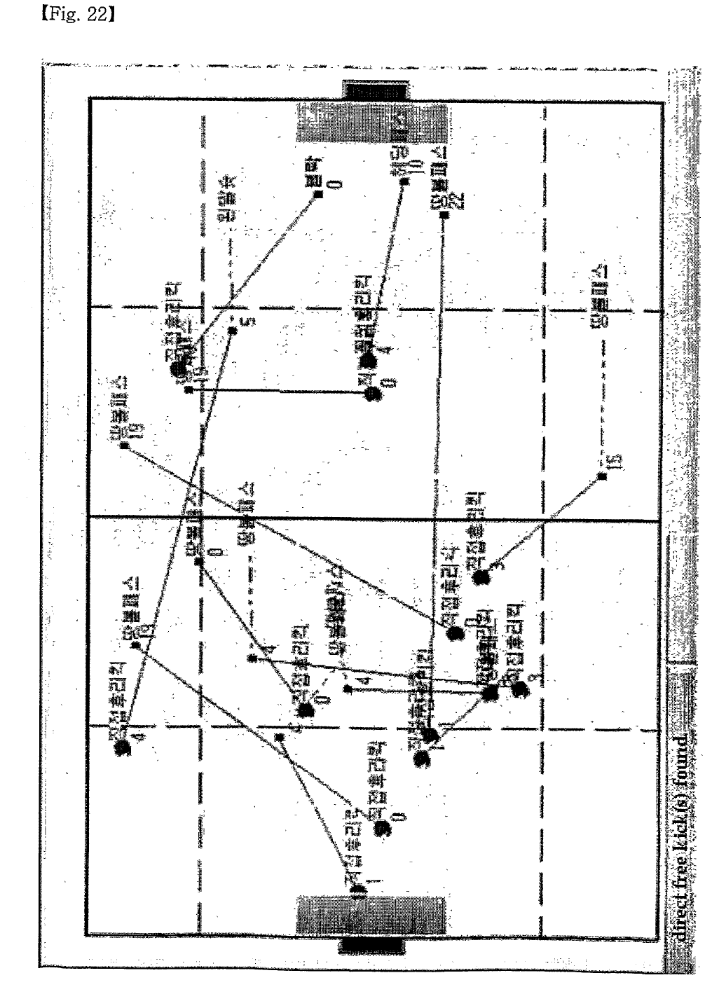

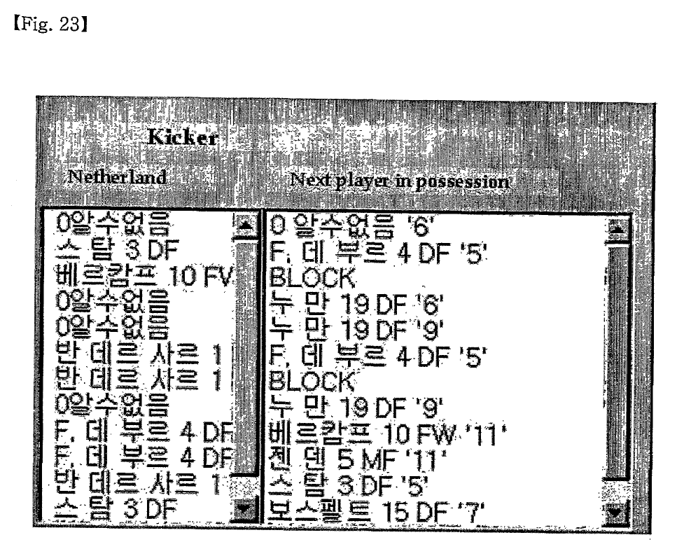

As shown in FIG. 22, a free kick can also be displayed. As shown in FIG. 23, both name of free kicker and of the next ball possessor are presented. Number at the end (‘6’, in this case) represents the player who received ball in area 6. Block means a free kicked ball did not get to players of the same team.

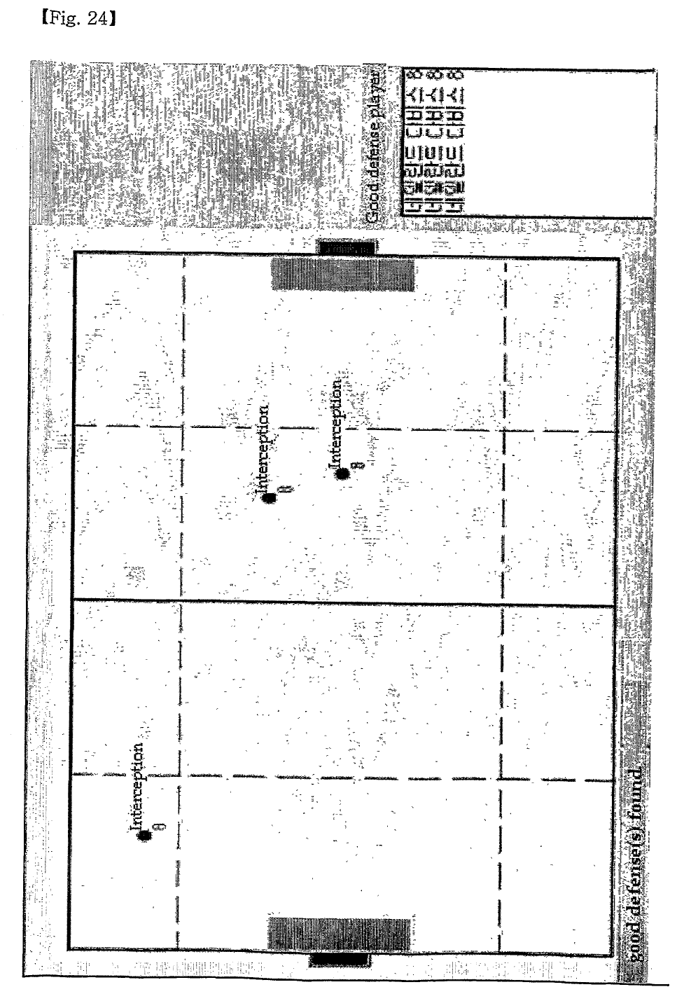

As shown in FIG. 24, in case that a pass from defenses such as clearing, intercept, cutting, and block is connected to a shooting, responsible defense player and the situation (page) are presented.

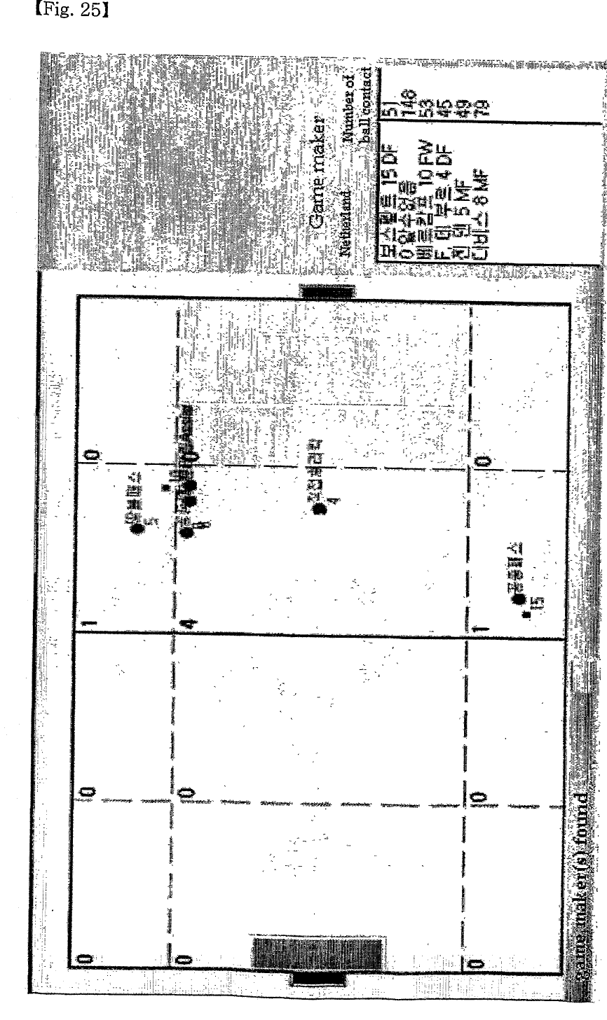

As shown in FIG. 25, when a user searches for players who placed a ball into area 2, having the most chance of a goal, 6 players were found and the players' locations are counted by area. Area 5 has 4, the largest number. In this case, the position is represented as x2, y2, which is different from the case of individual player record view, i.e. x1, y1, and x2, y2. Position of pass player (x2, y2) rather than position of ball possession player is counted.

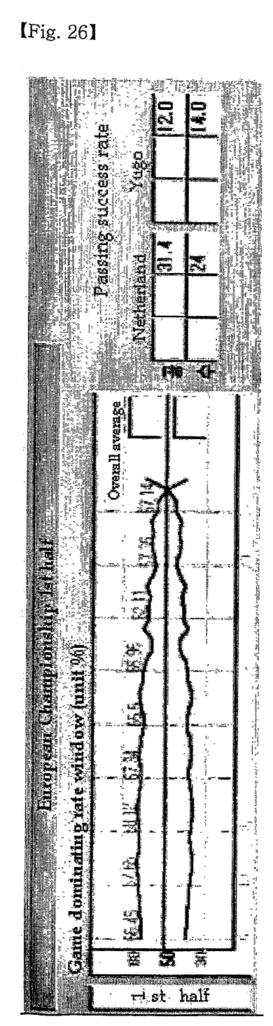

As shown in FIG. 26, after searching the whole records for a player assigned as a game maker and displaying the number of ball touch of the player, a ball possession time is calculated, and game domination rate is calculated in every 5 minutes and, after calculating each team's number of ball touch, displayed graphically with respect to each opponent team.

Code for calculating the game domination rate is exemplified in the following.

“If (Area=True And v_one=1) Or (Area=False And v_two=1) Then 1^{st} half if team A attacks toward the right side at the 1^{st} half and 2^{nd} half if team A attacks toward the left side at the 1^{st} half

str1=“and (x1<=367.5 or x2<=367.5) and team=‘B’”

The left side is team B's attack side.

str2=“and (x1>367.5 or x2>367.5) and team=‘A’”

The right side is team A's attack side.

Else

The opposite

str1=“and (x1>367.5 or x2>367.5) and team=‘B’”

str2=“and (x1<=367.5 or x2<=367.5) and team=‘A’”

End If”

For example, after finding all the tables for the first 5 minutes of 1^{st} half, counting numbers for team A and B, and calculating a ratio of the numbers, the result of the calculation is red-66.45% (team A) and blue-33.55% (team B) as shown in FIG. 26, where overall average is a ratio between total numbers of team A and team B.

Pass success rate for attacking area and defense area are calculated separately by counting the number of success in more than 4 passes successively. In FIG. 26, 55.4% of Netherlands' passes resulted in success, where 31.4% of them in attacking area and the others in defense area.

The method of soccer game record data analysis using computer network according to the present invention can be changed or modified to the extent that it does not damage the spirit of the present invention.

The present invention can be realized by a computer readable code in computer compatible recording media.

Computer compatible recording media include all of recording apparatus of which a computer system can read data.

For examples of the computer compatible recording media, there are ROM, RAM, CD-ROM, magnetic tape, floppy disk, and optical storage as well as one realized by carrier wave (for example, transmission via Internet).

The computer compatible recording media can be distributed to computer systems connected by network and the computer readable code can be saved and executed in a distributed way.

The present invention is not confined to the above described embodiment and can be changed and modified by the person who skilled in the art to the extent that it does not damage the spirit of the present invention.

Although the embodiment of the present invention describes itself only for soccer game record, it can be applied to all of the sports record data such as for basketball, volleyball, baseball, and ping-pong.

Therefore, the scope of the present invention is not limited to the exact construction and operation described in the embodiments, but only by the scope of the claims and the spirit thereof.

### INDUSTRIAL APPLICABILITY

As described above, using the soccer game record data analysis method using computer network, systems thereof, and computer compatible recording media for the data, it is possible to provide information promptly and easy to understand for users, so that the user can analyze players' movements in detail using various option selections, prove the capability of teams and players, and enhance the capability of the teams and players. Also, since the analysis results are provided in graphics so as to make it possible for users to easily understand, this invention can contribute to popularization of analysis information and can create new profit corresponding to it.

1. A method for analyzing soccer game record using at least one user computer and a server computer connected to each other through computer network characterized in that information of the moving path of the ball, the type of passing and the moving paths of the players of the soccer game record which is previously recorded is, in response to the analysis instruction inputted by a user, converted to the planar location data on a playground, and said location data analyzed according to said analysis instruction is displayed using symbols such as points, lines, characters/numbers, colors on a result window showing a playground.

2. A method for analyzing soccer game record using at least one user computer and a server computer connected to each other through computer network, said server computer comprising a game record database for storing soccer game record, a location data converting program for converting said soccer game record into location data and a result window display program for displaying said location data on a result window, comprising the steps of:
(a) selecting at least one predetermined instruction condition transferred from said user computer through said computer network;
(b) converting said soccer game record into location data by said location data converting program; and
(c) displaying said location data graphically onto a result window of said user computer by said result window display program.

3. The method of claim 2, wherein said step (a) comprises:
a game selection step for selecting a game of a team/date/place/sponsership/1^{st}-2^{nd} half/player/coach to be analyzed by the user;
a time selection step for selecting a specific time period from either of 1^{st} or 2^{nd} half of said game selected by the user; and
a option selection step for selecting information to be output among shoot type (left foot shoot/right foot shoot/heading shoot/other shoot), impact point, name/number of the player passing or receiving the ball, type of pass or kick (ball type), kind of event, goal success or fail, position of the player before shoot, diving direction, type of defense, motion, attempt distribution in a goal/score/team success rate/success rate in total, pattern of attack, pattern of assist, pattern of defense (clearing/intercept/cutting/block), individual game record, individual movement, defense position, ball possession time, comparative value of game domination rate (defined as the rate between the number of touching a ball per five minutes for each team).

4. The method of claim 2, wherein
said step (b) comprises the steps of finding the record data, corresponding to option condition selected in said option selection step, out of record data which contain soccer game record and X and Y coordinates of the location where said record occurred using result function, storing said X and Y coordinates of found records as location data, and storing image information of graphic pages corresponding to said location data and information about the selected option.

5. The method of claim 4, wherein
said step (b) is to split the playground into 12 areas, trisection along the sideline and quadrisection along the goal line, record which area each player is located in, and count the number of the player using functions such as “Count( )” and “CountArea( )”, which can be utilized of various statistics and graphics.

6. The method of claim 2, wherein
at least one saved graphic page(s) is displayed independently and/or at the same time on said result window and the information about selected option is overlapped on said result window in said step (c).

7. The method of claim 6, wherein
said graphic page describes the location of the player with a point on which player number and passing type are added, team with a color, dribbling distance with a dotted line, and passing distance with a solid line.

8. The method of claim 6, wherein said graphic page comprises:
a pattern page enabling to see players' location pattern; and
an individual game record page enabling to see locations of a specific player to check the individual game record.

9. The method of claim 2, wherein
said server computer comprises a statistics window display program for displaying various statistics based on the analysis on the soccer game record data, and
the method further comprising the step of:
(d) displaying various statistics based on the analysis on the soccer game record data as a numerical form by said statistics window display program.

10. A system for analyzing soccer game record using at least one user computer and a server computer connected to each other through computer network characterized in that said server computer comprises:
a game record database for storing soccer game record;
a location data converting program for converting said soccer game record into location data;
a result window display program for displaying said location data on a result window; and
a control unit programmed to select at least one predetermined instruction condition transferred from said user computer through said computer network, convert said soccer game record into location data by said location data converting program, and to display said location data graphically onto a result window of said user computer by said result window display program.

11. A computer-compatible record medium where a method for analyzing soccer game record using at least one user computer and a server computer connected to each other through computer network is stored recorded is characterized in that:
said server computer comprises a game record database for storing soccer game record, a location data converting program for converting said soccer game record into location data and a result window display program for displaying said location data a result window; and
said method comprises the steps of:
(a) selecting at least one predetermined instruction condition transferred from said user computer through said computer network;
(b) converting said soccer game record into location data by said location data converting program; and
(c) displaying said location data graphically onto a result window of said user computer by said result window display program.
